(19) United States
(12) Patent Application Publication
(10) Pub. No.: US 2015/0176740 A1
(43) Pub. Date: Jun. 25, 2015

(54) CONNECTING DEVICE AND CONNECTING SYSTEM WITH SAME

(71) Applicant: WOCO Industrietechnik GmbH, Bad Soden-Salmünster (DE)

(72) Inventor: Uwe Ludwig, Bad Soden-Salmunster (DE)

(21) Appl. No.: 14/416,560

(22) PCT Filed: Jul. 23, 2013
(86) PCT No.: PCT/EP2013/065474

§ 371 Date: Jan. 22, 2015

(30) Foreign Application Priority Data
Jul. 24, 2012 (DE) 10 2012 106 734.1
Jan. 22, 2013 (EP) 13152247.6

(51) Int. Cl. F16L 37/098

(52) U.S. Cl. CPC F16L 37/0982

(57) ABSTRACT

The present invention relates to a connecting device (5, 5′) for connecting at least two pipe parts, wherein the connecting device is connected at least in portions to a first pipe part, and a detachable connection to at least one connecting element (3, 4) operatively connected to a second pipe part (1) can be produced by means of said connecting device. The connecting device comprises at least one locking ring (7, 7′) with at least two elastically movable catch tabs (11 11′) protruding in a radially inward direction of the locking ring, and at least one actuator ring (9, 9′) for moving the catch tabs out of at least one locking position, in which at least one of the catch tabs is engaged in the connecting element, into at least one unlocking position in which the engagement is detached, and vice versa. The respective catch tab is resiliently mounted at a first end on the locking ring via at least one catch arm (21, 21′), and a second end of the catch tab opposite from the first end is freely movable. In addition, at least one guide element (13, 13′) is arranged in the area of the second end of the respective catch tab and the respective guide element is guided in at least one slot (15, 15′) comprised by the actuator ring, in such a manner that the catch tab can be forced into the locking position by a spring force built up by the catch arm, and can be forced out of the locking position against the spring force and into the unlocking position by means of a movement of the actuator ring relative to the locking ring and/or the locking ring relative to the actuator ring. The invention further relates to a connecting system comprising such a connecting device.

The present invention relates to a connecting device for connecting at least two pipe parts, wherein the connecting device is connected at least sectionwise to a first pipe part, and a detachable connection to at least one connecting element operatively connected to a second pipe part can be produced by means of said connecting device, the connecting device comprises at least one locking ring with at least two elastically movable catch tabs protruding in a radially inward direction of the locking ring, and at least one actuator ring for moving the catch tabs out of at least one locking position, in which at least one of the catch tabs is engaged in the connecting element, into at least one unlocking position in which the engagement is detached, and vice versa, wherein the respective catch tab is resiliently mounted at a first end on the locking ring via at least one catch arm, and a second end of the catch tab opposite from the first end is freely movable.

A multitude of such connecting devices is known from prior art. For example, document DE 100 30 030 C1 discloses an engaging connection of two pipe parts, in particular of the pipe socket of a tapping unit or a valve fitting on the one hand and the connecting fitting of a branch line on the other. The engaging connection joins an insertion pipe part and a holder pipe part. These include a cam ring consisting of a ring body and at least one radially projecting cam. The holder pipe part has an radial recess that is axially open and followed tangentially by an axially closed chamber that is associated with a control surface. It is proposed to make the cam radially movable relative to the ring body of the cam ring and to give the control curve in the chamber a radial profile such that it interacts with the outer radial cam profile when the cam ring is rotated. The cam provides a positive joint of the holder pipe part and the insertion pipe part.

However, the cam and the radial recess must be aligned against each other before making the connection of the pipe parts in the form of a bayonet joint. This complicates the joining process. In addition, an undercut must be configured on an inner surface of the holder pipe part, which makes it more complicated to produce the engaging connection, since a forming process requires the use of slider elements. Furthermore, the disclosed engaging connection does not make it possible to reliably detect from outside if the engaging connection is in a locking position or not. Moreover, the locking position is not of a self-locking type.

In addition, document U.S. Pat. No. 7,566,079 B1 discloses a connecting device of the generic type in question that has the form of a pipe coupling. It is suitable for connecting thermoplastic pipes to a metal intake port. When the port is inserted into the coupling, a snap lock connection is provided by a plurality of locking teeth that project radially inward through the housing from a collar to engage with the annular projection formed on the intake port. Disconnection of the intake port from the pipe is effected by rotation of the collar with respect to a housing of the coupling so that cam surfaces on the housing interact with the locking teeth to move the teeth radially outward to disengage from the projection.

It is a disadvantage of this connecting device that disconnecting this connection requires a comparatively high torque. Providing the pipe coupling also requires a plurality of individual components. At least three individual components, that is, a housing, a fastening ring, and a collar are required.

Document DE 195 51 223 A1 also discloses a connecting device of the generic type in question. But it poses the disadvantage that its longitudinal extension is relatively long, such that it cannot be used where installation space is limited. For example, it cannot be used where pipes are installed with bends. In addition, this connecting device has a complicated operating sequence.

It is therefore the object of this invention to further develop the connecting devices known from prior art, in particular, the connecting device of the generic type in question, in such a way that the disadvantages of prior art are overcome. In particular, a connecting device shall be provided that is of a simple constructive design and can easily be manufactured, particularly to reduce manufacturing costs, and at the same time requires only little force for its operation and enables reliable detection of a locking position and/or an unlocking position.

According to the invention, this object is achieved in that at least one guide element is provided in the vicinity of the second end of the respective catch tab and that the respective guide element is guided in at least one slot comprised by the actuator ring, in such a manner that the catch tab can be forced into the locking position by the spring force built up by the catch arm and can be forced out of the locking position against said spring force and into the unlocking position by means of a movement of the actuator ring relative to the locking ring and/or of the locking ring relative to the actuator ring.

It is particularly preferred that the first pipe part can be connected to the actuator ring or the locking ring using at least one first connecting device.

A connecting device according to the invention may also be characterized in that the connecting element is connected to the second pipe part, in particular by means of at least one second connecting device, in that it is formed at least sectionwise, preferably completely, in said second pipe part and/or comprises at least one receptacle for the catch tab, in particular including at least one recess, at least one groove and/or at least one undercut, wherein said receptacle preferably encompasses the second pipe part completely.

It is further preferred that the connecting element comprises at least a first stop element for the connecting device, in particular the locking ring and/or the actuator ring, preferably for limiting a movement of the connecting device in an axial direction along a first axis, wherein said first axis preferably corresponds to a longitudinal axis of the first pipe part and/or the second pipe part and/or a symmetry axis of the actuator ring and/or the locking ring.

The invention also proposes that the locking ring can be radially pushed or slid onto outside sections of the actuator ring and/or can be disposed on said actuator ring such that it radially surrounds at least sections thereof, or that the actuator ring can be radially pushed or slid onto outside sections of the locking ring and/or can be disposed on said locking ring such that it radially surrounds at least sections thereof, wherein the actuator ring and the locking ring can preferably be connected by means of at least one third connecting device, preferably in such a manner that a movement in an axial direction is prevented and a rotational movement of the actuator ring relative to the locking ring about the first axis is possible.

In another embodiment of the invention, the locking ring or the actuator ring can be opened and/or closed at least at one circumference point by means of at least one fourth connecting device, wherein preferably a plurality of individual segments of the locking ring or the actuator ring are provided which can be connected to each other via a plurality of fourth connecting devices.

The invention also proposes that the catch tab and/or the catch arm is supported at least in the locking position in a direction along the first axis by at least one second stop element encompassed by the actuator ring and/or comes into contact with the second stop element when a force acting onto the connecting device in the direction of the first axis builds up, wherein particularly the catch tab, at least in the locking position, at least sectionwise, projects into, or extends through, at least one opening formed in the actuator ring.

It is particularly preferred that the catch tab and/or the catch arm extend(s) substantially in a direction perpendicular to the first axis and/or tangential to a circumferential direction of the locking ring and/or actuator ring.

Another embodiment of the invention proposes that the catch tabs comprise at least one bevel in a direction along the first axis, particularly in order to achieve a deflection of the catch tab and/or the catch arm out of the locking position by sliding the second pipe part along the first axis into the actuator ring and/or the locking ring.

Furthermore, a connecting device may be characterized in that the guide element includes at least one bolt extending parallel to the first axis and/or that preferably at least two guide elements are provided, preferably disposed on opposite sides of the catch tab.

Advantageously, the slot may include at least one guideway on which the guide element rests, is forced into contact with the guideway, in particular by means of the spring force built up by the catch arm, wherein said guideway is preferably inclined with respect to a circumferential direction about the first axis, particularly the surface of the guideway on which the guide element rests extends at different radial distances from the first axis.

The above embodiment may be characterized in that the inclination with respect to the circumferential direction about the first axis is at least sectionwise 5° to 40°, preferred 10° to 35°, preferred 15° to 20°, more preferred 20° to 25°, most preferred 22°, the guideway being curved along the circumferential direction about the first axis and/or the inclination decreasing as the radial spacing from the first axis decreases.

In the above embodiments, it is particularly preferred that at least one surface contour section is configured in the surface of the guideway that provides a parking position of the connecting device, particularly the locking ring, the catch tab, the catch arm, and/or the guide element, the surface of the guideway preferably comprises a constant radial distance from the first axis for providing the parking position, and/or the distance of the surface of the guideway from the first axis increases at least sectionwise in both circumferential directions, starting from the surface contour section that provides the parking position.

It is further proposed for the invention that the actuator ring, particularly the slot, is designed such that, for transferring the catch tab from the locking position into the unlocking position, the actuator ring is moved across an angular range from 2° to 12°, preferred from 4° to 10°, more preferred from 5° to 9°, even more preferred from 6° to 8°, and most preferred by 7°.

It is also proposed that the catch arm is supported by the slot at least sectionwise along the first axis, particularly rests flatly, at least sectionwise, in a plane perpendicular to the first axis on the surface of the slot.

The connecting device according to the invention may further be characterized by at least one latching device for latching, particularly rotation-proof latching, of the actuator ring relative to the locking ring with respect to the first axis in at least one first latching position, particularly in the parking position, said latching position preferably corresponding to the unlocking position of the catch tabs.

It is particularly preferred in this context that the latching device includes at least one latching element that is connected in a rotation-proof manner to a first element and/or movably, preferably in a direction along the first axis, mounted in said first element, wherein a second element is latched by means of said latching element relative to the first element in the latching position, particularly said latching element engaging in a recess of the second element and/or said latching element being forced into engagement with said recess by at least one restoring device, such as at least one spring element.

The invention also proposes that the latching device includes at least one trigger element for releasing the latching of the actuator ring relative to the locking ring, in particular for moving the latching element out of its engagement, preferably against a restoring force built up by the restoring device.

It is particularly preferred that the trigger element and the locking element are at least sectionwise integral.

It is also proposed that the first element is the locking ring and the second element is the actuator ring, or that the first element is the actuator ring and the second element is the locking ring.

Furthermore, a connecting device may be characterized in that the trigger element is at least sectionwise disposed on a side of the actuator ring that is facing away from the locking ring, in particular, that the trigger element extends at least sectionwise through the actuator ring, that the trigger element can preferably be brought into contact with the second pipe part, in particular when the latching device is in the latching position.

The invention further proposes that the actuator ring is preloaded with respect to the locking ring in the latching position by the spring force built up by the catch arms.

The invention further proposes that the actuator ring comprises at least one first marking and the locking ring comprises at least one second marking, wherein the first marking and the second marking are aligned flush with each other when the connecting device, particularly the catch tab, is in the locking position, and/or the first marking and the second marking are not flush when the connecting device, particularly the catch tab, is in the unlocking position, the latching position, and/or the parking position.

A connecting device according to the invention may be characterized by at least one control ring that can be arranged coaxially to the actuator ring and/or the locking ring, wherein said control ring comprises at least one third marking, wherein particularly this third marking on the one hand and the first and second markings on the other are aligned flush with each other in the locking position of the connecting device and are not aligned flush with each other in the unlocking position, the latching position, and/or the parking position.

It is particularly preferred that the control ring includes at least one recess for receiving the guide element and/or the second end of the catch tab at least sectionwise, wherein said recess is preferably inclined relative to a radial direction of the first axis.

The connecting device may furthermore be characterized by at least one cover ring that can be disposed coaxially with the actuator ring, the locking ring, and/or the control ring, wherein said cover ring includes at least one spring hammer element that can be transferred from a resting position into a triggering and/or indicator position by means of the guide element, wherein the resting position is taken when the connecting device is in the locking position and/or the triggering position is taken when the connecting device is in the unlocking position, latching position, and/or parking position of the connecting device.

In the embodiment of the invention described above, the spring hammer element may further be resiliently seated in the cover ring, wherein this type of seating can build up a restoring force that forces the spring hammer element into the resting position and/or the spring hammer element projects in the triggering and indicator positions from the surface of the residual area of the cover ring, wherein said spring hammer element, particularly in the triggering and/or indicator position, is operatively connected with the guide element and/or trigger element, particularly abutting with it or them, in such a manner that a movement of the spring hammer element from the triggering and/or indicator position into the resting position preferably caused by a force acting on the spring hammer element, particularly a force in addition to the resilient seating, can move the guide element from the parking position, particularly the locking position, and/or the latching element from the latching position, wherein this movement can preferably be produced during a movement of the cover ring and/or the spring hammer element against the connecting element, particularly the first stop element.

The two embodiments of a connecting device mentioned above may be characterized in that the cover ring comprises at least one fourth marking, wherein this fourth marking on the one hand and the first marking, the second marking, and/or the third marking on the other hand are aligned flush with each other in the locking position of the connecting device and are not aligned flush with each other in the unlocking position, the latching position, and/or the parking position of the connecting device.

It is preferred that the first marking, the second marking, the third marking, and/or the fourth marking includes at least one indentation, at least one elevation, at least one imprint, and/or at least one relief.

It may further be contemplated that the actuator ring and/or the locking ring includes at least one sealing device, preferably comprising at least one O-ring, and/or can be connected to the sealing device, and particularly includes at least one recess, such as at least one groove, at least one indentation, and/or at least one undercut for receiving the sealing device.

Finally, it is proposed for a connecting device that the first connecting means, the second connecting means, the third connecting means, and/or the fourth connecting means include(s) at least one snap-lock connection, at least one clamping connection, at least one adhesive connection, at least one clip connection, at least one bayonet connection, and/or at least one screwed connection.

The invention further provides a connecting system comprising at least one connecting device according to the invention that is connected to a first pipe part and at least one connecting element that can be connected to a second pipe part and/or is, at least sectionwise, preferably completely, encompassed by said second pipe part.

The invention is therefore based on the surprising finding that a connecting device can be designed in such a manner that a force required for operating the connecting device, particularly for transferring the same from a locking position into an unlocking position and vice versa, can be reduced in that a catch tab is actuated by means of at least one guide element that is disposed on a freely movable end of a catch tab. Since the guide element is disposed at an end of the catch tab that is facing away from an end of the catch tab at which the catch tab is resiliently connected to a locking ring via a catch arm, a maximum possible lever arm is available for overcoming the spring force by which the catch tab is forced into the locking position. In the connecting devices known from prior art, coupling is thus effected on the first end of the catch tab, where the same is connected to the catch arm or the locking ring, whereby a greater torque must be applied to the actuator ring or locking ring, respectively, to overcome the spring force which forces the catch tabs into the locking position.

Since the spring force acting on the catch tabs and generated by the catch arm causes the catch tab to move in the direction of the locking position, this design also provides a self-locking connecting device. This spring force forces the catch tab into the locking position without applying force to the locking ring and/or the actuator ring, and in the case where the connecting element of the second pipe part is disposed in the area of the connecting device, the catch tabs become engaged with the connecting element to make the connection of the first pipe part and the second pipe part.

The first pipe part may for example be fastened by means of a screwed or slip/clamp connection.

It is particularly preferred that the connecting element is configured directly on the second pipe part, for example as a peripheral undercut. This once again reduces the number of individual elements required for making the connection between the first pipe part and the second pipe part. If the connecting element and the second pipe part cannot be configured as an integral unit, the connecting element may also be provided as a separate unit. It can be connected to the second pipe part using suitable connecting devices, such as a screwed or clip connection. When it comes to the shape of the connecting element, it is particularly preferred that it is radially symmetrical. This allows connecting the two pipe parts at any relative angles, which simplifies the installation process considerably, for example, compared to an installation based on the bayonet catch principle. If a predefined alignment of the pipe parts to each other is desired, particularly for pipe parts that are not radially symmetrical, during installation the connecting element, but also the locking ring, can be radially asymmetrical, particularly with respect to the arrangement of the catch tabs and receptacles across the respective circumference.

Configuring a first stop element has the advantage that a movement of the connecting device relative to the second pipe part, particularly the connecting element, is limited to ensure smooth engagement of the catch tabs with the connecting element in the locking position and thus a reliable connection of the pipe parts.

Particularly in the case in which the locking ring radially encompasses the actuator ring or vice versa, it is necessary that the locking ring can be placed onto the actuator ring or vice versa in such a way that the catch tabs can project through the actuator ring to achieve engagement with the connecting element while at the same time the guide elements can be brought into an operative connection with the slot. Under certain limiting conditions, for example, when guide elements are provided on both sides of the catch tab, the locking ring cannot be slid onto the actuator ring and vice versa in an axial direction along the first axis. It is envisaged that the locking ring or the actuator ring, respectively, is designed such that it can be opened at at least one point by means of the fourth connecting means similar to a lock geometry to avoid a complicated manufacturing process when the locking ring and actuator ring are produced simultaneously, particularly, when the locking ring has to be configured on the actuator ring or vice versa. In this way, the locking ring or actuator ring, respectively, can be opened to be placed onto the actuator ring or locking ring, respectively, and is subsequently closed by means of the fourth connecting means. Furthermore, the locking ring or actuator ring, respectively, can be formed by a plurality of individual segments to realize a modular design and to adapt the locking ring or actuator ring, respectively to the respective limiting conditions.

When the catch tabs project into respective openings formed in the actuator ring, in particular, when they project through these openings in the locking position, the edges of the openings act as second stop elements for the catch tabs. Forces that act on the pipe parts or the connecting device, respectively, particularly tensile and shear forces, are transferred from the catch tabs to the actuator ring by the second stop element and dissipated. This means that the catch tabs, particularly the catch arms, are exposed to pure shearing loads, no buckling loads, resulting in a high load rating. The second stop element can also be provided if the actuator ring does not feature an opening, for example by the trailing edge of the actuator ring.

Since the catch arms rest flatly, at least sectionwise, on the actuator ring or the slot configured therein in a plane perpendicular to the first axis, the catch arms and catch tabs are properly guided and can readily absorb shear forces, particularly dissipated from the catch arms, which results in a high load rating, particularly for shear forces.

Since the catch tabs and catch arms extend in a circumferential direction and not in direction parallel to a symmetry axis of the actuator ring or locking ring, respectively, the catch arms, particularly their geometry such as their length, and the spring forces associated with them can be varied in a wide range without having to change the extension of the connecting device in the direction of the symmetry axis. In this way, a very compact design of the connecting device can be achieved.

If bevels are provided on the catch tabs, the second pipe part can be fastened to the connecting device or the first pipe part, respectively, without additional operation of the locking ring or the actuator ring, respectively. The bevel causes a deflection of the catch tab out of the locking position against the spring force built up by the catch arms when the second pipe part, particularly the connecting element, is inserted into the connecting device, and upon reaching an end position, particularly upon reaching the first stop element, the catch tabs “snap back” into the locking position and thus become engaged in the receptacle of the connecting element.

The formation of additional guide elements on the second end of the catch tabs clearly simplifies the design of the connecting device. For example, this step eliminates the need for separately forming the collar and the cam face on a separate housing known from prior art, which further reduces the number of individual components, since the slot can be configured directly on the actuator ring. The formation of multiple guide elements on opposite sides of the catch tab further holds the advantage that the force acting on a single guide element can be reduced and a force can be transferred more uniformly into the catch tab or catch arm, respectively, via the guide elements. This prevents a torsional motion, which could result in premature fatigue and failure.

This means that only two components are required for the functioning of the connecting device, the actuator ring and the locking ring. Applying a texture to the outside of the actuator ring allows direct incorporation of a non-skid surface for transferring the torque to the actuator ring for rotational manipulation.

Furthermore, the connecting device can be adjusted to connecting elements already available on second pipe parts in prior art and is thus compatible with these. No additional counterparts of the connecting device, that is, no additional connecting elements are required.

The rotational movement of the actuator ring is converted into a movement of the catch tabs or catch arms, respectively, radially outward due to the special course of the guideway of the slots on which the guide element(s) rest(s), wherein said guideway is inclined with respect to a circumferential direction about the first axis, and particularly because the surface of the guideway on which the guide element rests runs at different radial distances from the first axis. The loss of force is minimized in this way, and the force to be built up on the actuator ring does not need an extra increase; in particular, the catch arms experience the best controlled movement across the slot or guideway due to bolts configured on the catch tabs or catch arms, respectively.

Only small angles of rotation of the actuator ring from the locking position into the unlocking position of the catch arms, e.g. 7°, will be required if a suitable inclination of the slot or guideway, respectively, for example 22° relative to a tangent to the circumferential direction, is selected, while such selection at the same time ensures automatic resetting of the actuator ring and the catch arms through the restoring force built up by the catch arms. This can prevent unintended incorrect positioning and facilitate comparatively long travels of the catch arms with relatively little rotational movement.

Providing a parking position in the guideway has several advantages. In the parking position, the catch tabs are in the unlocking position and are held without the need to build up or maintain a force on the actuator ring. Therefore the connecting device can be arranged in a position relative to the second pipe part in which the catch tabs become engaged in the connecting element when switching into the unlocking position without operating the actuator ring. When the second pipe part is positioned relative to the connecting device, no additional force has to be built up to move the catch tabs against the spring force out of the locking position. After reaching the position in which the second pipe part rests against the connecting device, particularly via the first stop element, the actuator ring can simply be moved out of the parking position. Due to the shape of the slot or guideway, respectively, a movement of the actuator ring into a locking position of the catch tabs by means of the spring force built up by the catch arms is then supported, and only little force is needed to fasten the pipe parts to each other.

The parking position can be provided by a section of the guideway in which the guide element remains radially equidistant for various rotational positions of the actuator ring and the locking ring relative to each other. This reduces the force required to leave the parking position.

However, the parking position can be left by just a minor unintended application of force, and the connecting device can unintentionally be transferred into the locking position. If a parking position is configured by providing an indentation in the guideway, the actuator ring can only be moved relative to the locking ring against the spring force built up by the catch arms. Only after overcoming this elevation, the guide element once again gets into an area in which the radial distance diminishes and the actuator ring is forced into the locking position.

The guideway must be shaped such that the inclination toward the tangent to the circumferential direction is not constant but creates a curvature. This curvature is preferably directed radially outwards, so that the inclination decreases with increasing radial distance to the first axis. In this way, the restoring force that increases with increasing deflection of the catch arms in the direction of the unlocking position is compensated and the actuator ring can be rotated using a uniform force. This curvature at least prevents an increase in force when moving from the locking into the unlocking position, to the effect that the force applied from the beginning to the end of the movement is almost equal.

Alternatively, or in addition, the actuator ring can be latched relative to the locking ring in a latching position, which in particular corresponds to the unlocking position of the catch tabs. A latching device can be provided for this purpose as an alternative or in addition to the parking position configured in the guideway. The latching device makes it possible to prevent a relative rotational movement of the actuator ring and the locking ring after the actuator ring was moved or rotated relative to the locking ring in such a way that the catch tabs are in the unlocking position. The latching device has the advantage that there will be no movement of the actuator ring relative to the locking ring despite the restoring force built up by the catch arms and that, in particular, the catch tabs do not move into the locking position by themselves. The latching device includes a latching element which prevents rotation of the actuator ring relative to the locking ring by friction and/or positive locking interaction. It is particularly advantageous in this context that the latching is not released when exposed to external influences, such as vibrations or the like. Therefore providing a latching device is particularly advantageous to keep the connecting device in an unlocking position during transport. Advantageously, the latching element is forced into the latching position, such as a friction and/or positive locking engagement, by means of a restoring device.

If one wishes to transfer the connecting device from the latching position to the locking position, the latching device can be brought out of the latching position by means of a trigger element. The trigger element is advantageously designed in such a manner that it is actuated when the second pipe part, particularly the connecting element, is brought into an operative connection with the connecting device. It is contemplated that the friction and/or positive locking connection made by the latching element is released by the trigger element. If the latching position corresponds with the unlocking position of the connecting device, the actuator ring is moved automatically from the unlocking into the locking position due to the spring force built up by the catch arms and the interaction of the catch arms with the actuator ring via the guideway. In this way, automatic joining of the two pipe parts is achieved in a simple manner. For example, an installer can simply bring the connecting device that has been kept in the latching position using the latching device during transport into an operative connection with the second pipe part and thereby produce an automatic connection of the two pipe parts, wherein the connecting device is transferred from the unlocking position into the locking position due to the automatic operation of the trigger element, without any further steps, when the two pipe parts are brought together, thereby producing a connection between two pipe parts.

The special design of the guideway in conjunction with additional guide elements, particularly in the form of bolts, makes it possible to indicate whether the connecting device is in the locking position or outside of the locking position. Surface areas of both the actuator ring and the locking ring are visible from outside. The locking position, that is, a safe connection of the two pipe parts, can be reliably detected from outside by applying suitable markings at predetermined circumferential positions of the actuator ring in the form of first markings and of the locking ring in the form of second markings. For example, these markings can be arranged in such a manner that they are only in flush alignment when the catch tabs and therefore the connecting device are in the locking position.

This indicator effect can be enhanced or supported by using a control ring. The control ring makes it possible to indirectly determine the position of the catch tabs based on the position of the guide elements. Recesses are provided in the control ring in which the guide elements, particularly the bolts, engage. Since these recesses are oblique in a radial direction, moving the guide elements in the radial direction causes a rotational movement of the control ring relative to the actuator ring or the locking ring, respectively. The control ring is thus in a predetermined rotational position when the catch tabs are in the locking position, particularly with respect to a radial position, or the guide elements are in a position that corresponds to the locking position of the catch tabs. The position of the control ring relative to the actuator ring or the locking ring, respectively, that corresponds to the locking position of the catch tabs can be indicated using respective third markings.

A cover ring as claimed may be provided alternatively, or in addition to, the control ring and/or the latching device. This cover ring comprises a spring hammer element that can be brought into an operative connection with the guide element. This spring hammer element can be arranged and designed such that it can be transferred from a resting position into a triggering and/or indicator position by the guide element. For example, the spring hammer element can project from the surface of the cover ring in the triggering and/or indicator position and in this way indicate a specific position of the guide elements or catch tabs, respectively. For example, the triggering and/or indicator position can be taken when the guide element or the catch tab, respectively, is outside the locking position, e.g. in the parking position and/or latching position. A user or installer can in this way be alerted that the connecting device is not in the locking position. The spring hammer element can also support a movement of the guide element out of the parking position or a movement of the trigger element, in that a restoring force that supports the spring force built up by the catch arms is built up in the direction of the locking position and transferred to the catch tabs via the guide elements. The guide element and therefore the catch tab can also be forced from the parking position and/or the latching position by applying a force on the spring hammer element. This force may for example be generated when the spring hammer element contacts the stop element of the second pipe part. This particularly triggers the “snapping back” of the catch tabs into the locking position as described above, if these are in the parking position and/or the latching position when the second pipe part is inserted.

Other features and advantages of the invention can be derived from the description below, which explains preferred embodiments of the invention with reference to schematic figures. Wherein

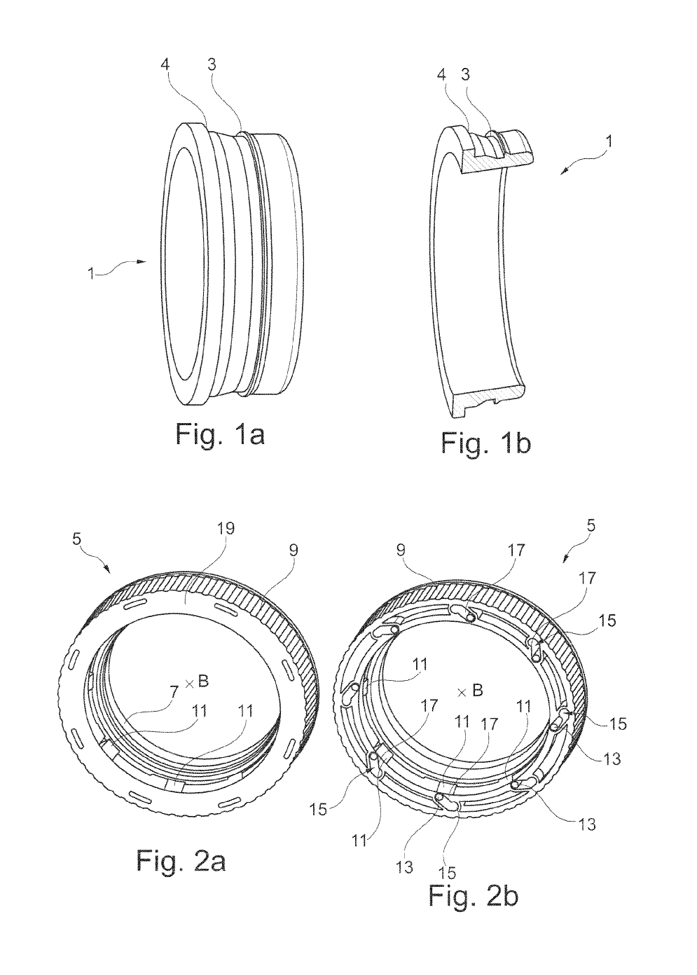

FIG. 1a shows a perspective view of a pipe part to be connected;

FIG. 1b shows a cross-sectional view of the pipe part from FIG. 1a:

FIG. 2a shows a perspective plan view of a first embodiment of a connecting device according to the invention;

FIG. 2b shows a cross-sectional view of the connecting device from FIG. 2a;

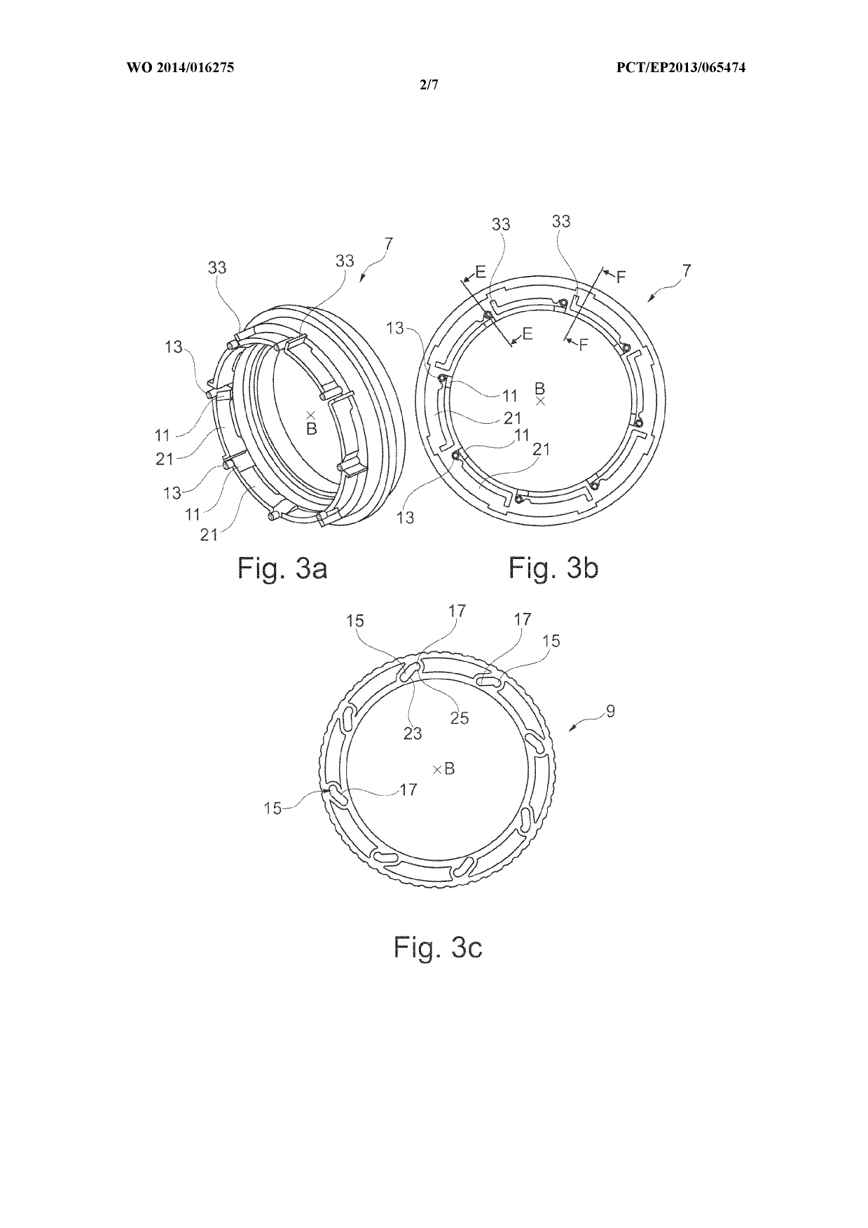

FIG. 3a shows a perspective plan view of a locking ring of the connecting device from FIGS. 2a and 2b;

FIG. 3b shows a side view of the locking ring from FIG. 3a;

FIG. 3c shows a plan view of an actuator ring of the connecting device from FIGS. 2a and 2b;

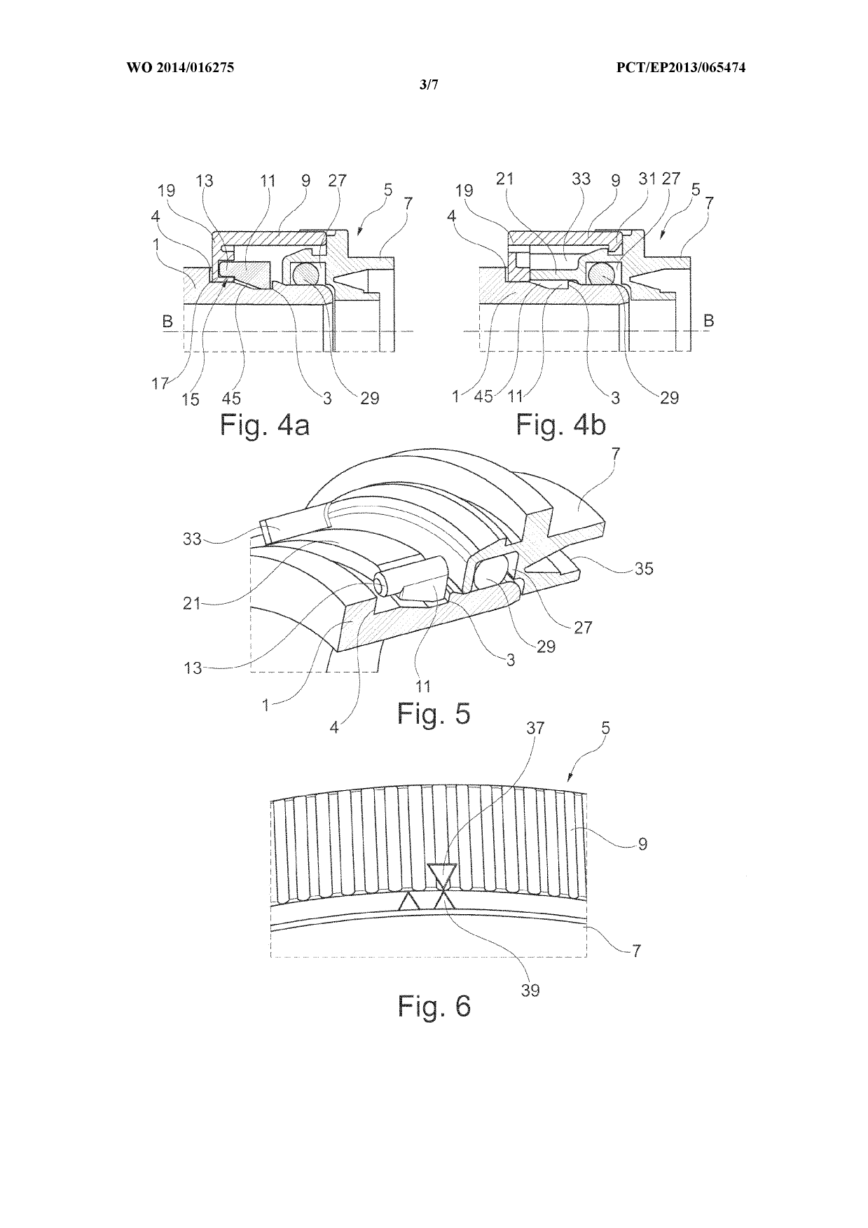

FIG. 4a shows a cross-sectional view of the connecting device of FIGS. 2a and 2b after joining with the second pipe part of FIGS. 1a and 1b in a locking position;

FIG. 4b shows a cross-sectional view in accordance with FIG. 4a, in a different circumferential section;

FIG. 5 shows a perspective cross-sectional view onto the connecting device in the locking position;

FIG. 6 shows a plan view of markings of the connecting device from FIGS. 2a and 2b disposed on the locking ring and on the actuator ring;

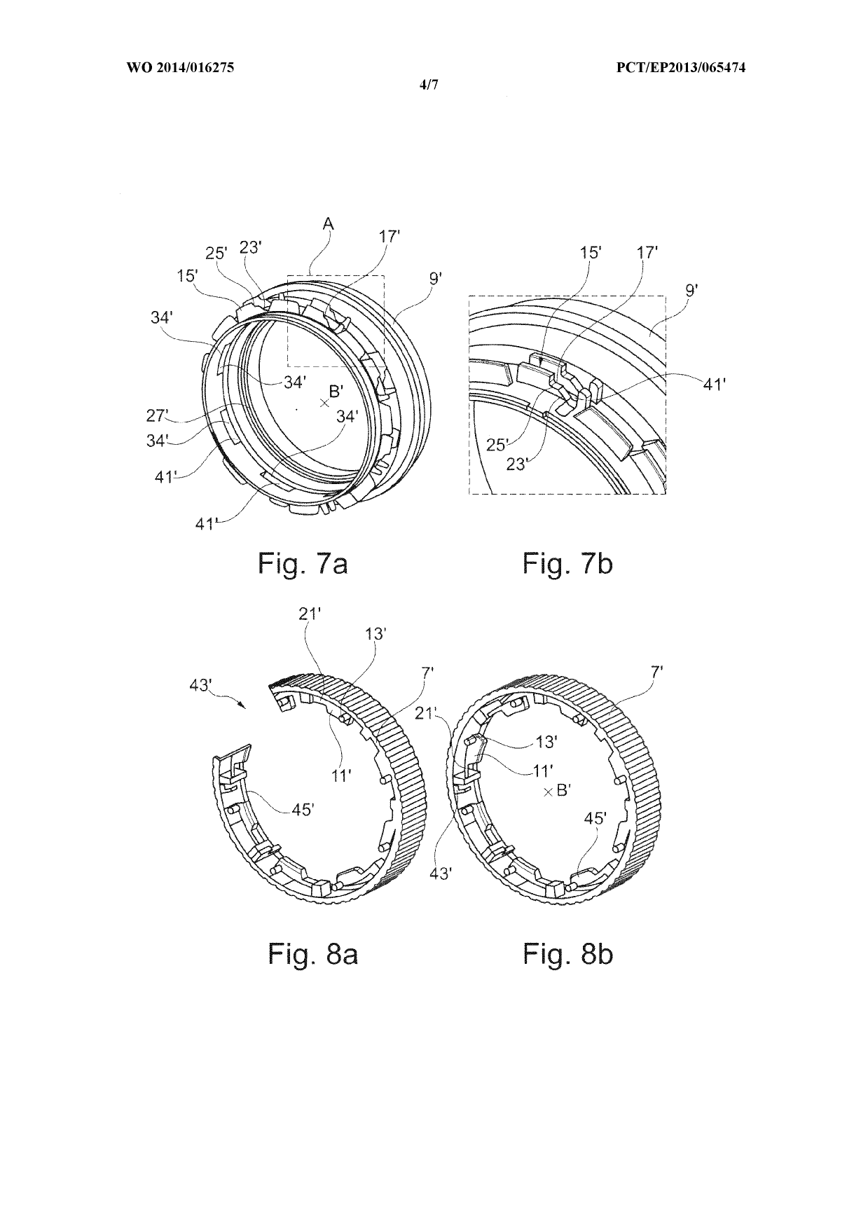

FIG. 7a shows a perspective plan view of an actuator ring according to a second embodiment of a connecting device according to the invention;

FIG. 7b shows a detailed view according to section A of FIG. 7a;

FIG. 8a shows a perspective plan view of a locking ring according to the second embodiment of the connecting device in an open position;

FIG. 8b shows a perspective plan view of the locking ring of FIG. 8a in an closed position;

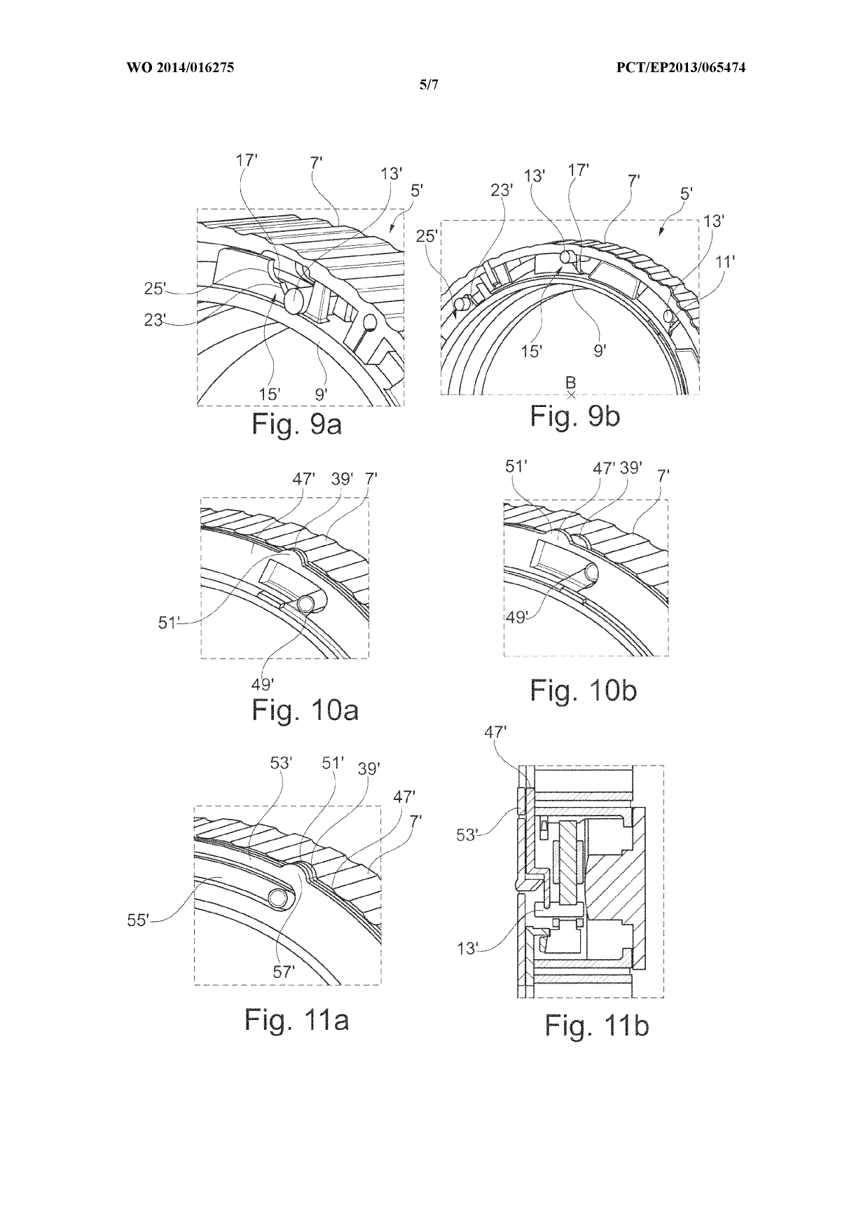

FIG. 9a shows a perspective plan view of the actuator ring of FIGS. 7a and 7b and the locking ring of FIGS. 8a and 8b in a locking position;

FIG. 9b shows a plan view like the one in FIG. 9a in the unlocking position:

FIG. 10a shows a plan view of a control ring in a locking position of the connecting device;

FIG. 10b shows a plan view like the one in FIG. 10a in an unlocking position;

FIG. 11a shows a plan view of a cover ring according to the second embodiment of the connecting device in a locking position;

FIG. 11b shows a cross-sectional view of the second connecting device in the locking position;

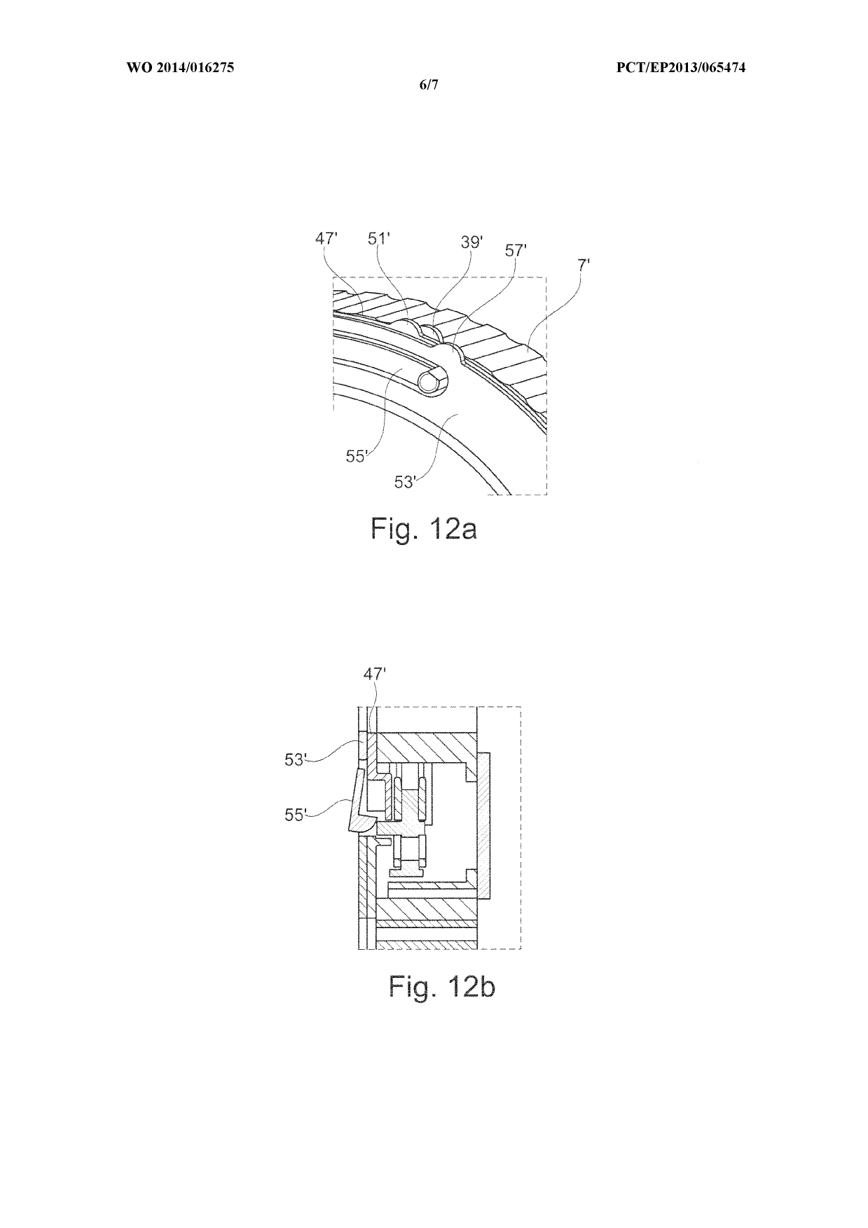

FIG. 12a shows a plan view like the one in FIG. 11a in an unlocking position;

FIG. 12b shows a cross-sectional view like the one in FIG. 11b in an unlocking position;

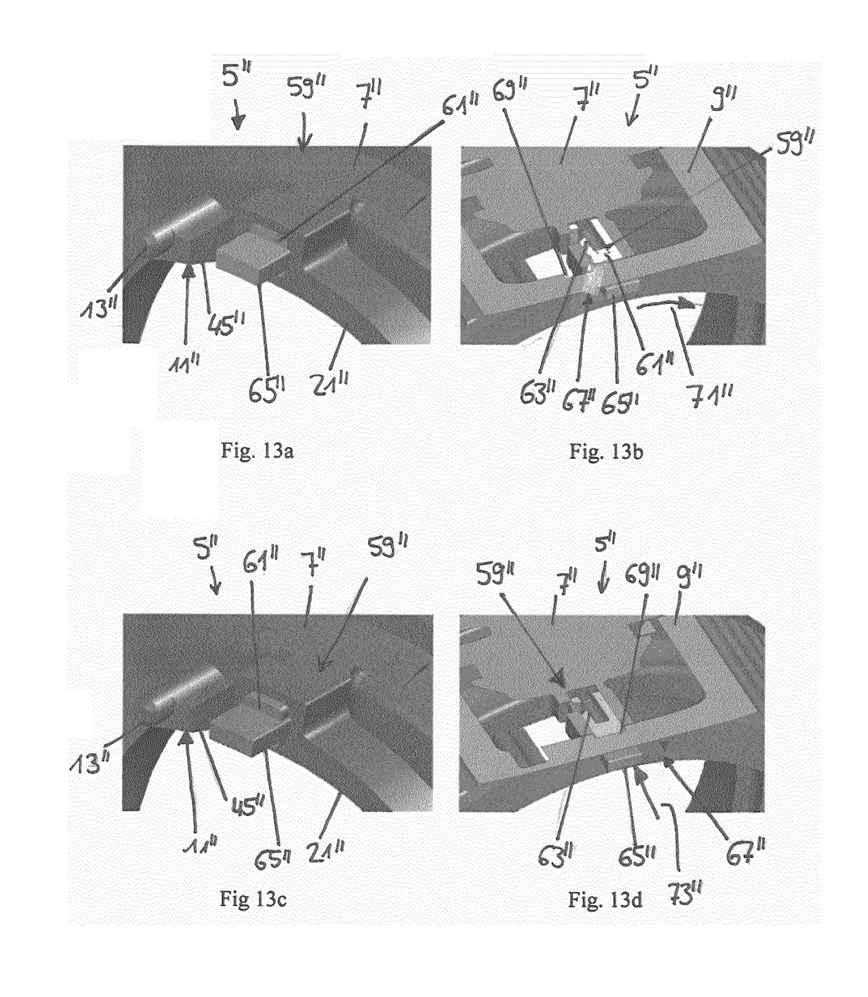

FIG. 13a shows a plan view of a locking ring according to a third embodiment of the connecting device which includes a latching device;

FIG. 13b shows a plan view of the locking ring of FIG. 13a together with an actuator ring, wherein the connecting device is in a locking position;

FIG. 13c shows a plan view of the locking ring of FIG. 13a, wherein the latching device is in a latching position; and

FIG. 13d shows a plan view like the one in FIG. 13b onto the connecting device in the latching position.

The present invention provides a connecting device by means of which at least two pipe parts can be connected to each other. A first pipe part, which is not shown, is directly connected to the connecting device, wherein the connecting device facilitates a detachable connection with a second pipe part 1, as shown, for example, in FIGS. 1a and 1b. The second pipe part 1 includes a connecting element in the form of an undercut 3. According to the second pipe part 1 shown in FIGS. 1a and 1b, the connecting element is integral with the pipe part 1 in the form of an undercut 3. In addition, the connecting element includes a first stop element in the form of a step 4. This stop element is also integral with the second pipe part 1. In other embodiments not shown here, the connecting element may also be designed as a separate component that is joined with the second pipe part.

FIG. 2a shows a perspective top view onto a connecting device 5 according to a first embodiment of the invention. FIG. 2b is a cross-sectional view of the connecting device 5. The connecting device 5 includes a locking ring 7 and an actuator ring 9. As can be derived from FIG. 2b, the locking ring 7 comprises a plurality of catch tabs 11. The catch tabs 11 project radially inward from the locking ring 7 with respect to a symmetry axis B. Guide elements in the form of bolts 13, which substantially extend in a direction parallel to the axis B, are configured on the catch tabs 11. The bolts 13 engage in a slot 15 configured on the actuator ring 9. The slots 15 comprise guideways 17. The actuator ring 9 is covered by a cover 19 on the side facing away from the locking ring 7. This cover 19 is not shown in FIG. 2b.

The locking ring 7 of the connecting device 5 is shown in greater detail in FIGS. 3a and 3b, while FIG. 3c shows a more detailed view of the actuator ring 9.

As can be seen from FIGS. 3a and 3b, the catch tabs 11 on which the guide elements are configured in the form of bolts 13 are resiliently disposed on the locking ring 7. Both the catch arms 21 and the catch tabs 11 extend along a circumferential direction of the locking ring 7, that is, tangential to a circumferential direction about the symmetry axis B. In this way, the length of the catch arms 21 and thus the spring force generated by the catch arms 21 can be changed without having to lengthen the extension of the locking ring 7 in a direction parallel to the symmetry axis B.

FIG. 3c shows the slots 15 within the actuator ring 9 into which the bolts 13 engage. As can be seen from FIG. 3c, the guideways 17 configured in the slots 15 are inclined with respect to the circumferential direction of the actuator ring 9. Different sections 23, 25 of the slot 15 or the guideway 17, respectively, are disposed at different radial distances from the symmetry axis B. Section 25 defines a so-called parking position.

As can be seen in particular from FIG. 2b, rotation of the actuator ring 9 relative to the locking ring 7 causes the catch tabs 11 to be deflected radially outwards due to the guidance of the guide elements 13 in the slot 15 or the guideway 17, respectively, namely against a spring force built up by the catch arms 21. As can be derived from FIG. 3c, the guideway 17 extends at an equal radial distance with respect to the symmetry axis B in section 25. This has the effect that the guide elements in the form of the bolts 13 can be transferred to this section 25 by rotating the actuator ring 9. Since there is no inclination in Section 25, they take a stable position between the locking ring 7 and the actuator ring 9. The spring force built up via the catch arms 21 then ensures that the bolts 13 rest on the guideway but no torque is induced into the actuator ring 9. In this way, the connecting device 5 can be stably held in the parking position, which corresponds with the unlocking position.

FIG. 4a shows a cross-sectional view in the direction E in FIG. 3b of the connecting device 5 in a locking position. As can be derived from FIG. 4a, the pipe part 1 has been slid into the connecting device 5. The step 4 forms a stop for the actuator ring 9. The catch tab 11 is in this locking position of the connecting device 5 in engagement with the undercut 3. This prevents movement of the second pipe part 1 in the direction of the first axis B.

As can further be seen from FIG. 4a, an indentation 27 is configured inside the locking ring 7 in which a sealing element in the form of an O-ring 29 is disposed.

As can be seen from FIG. 4b, which shows a cross-sectional view of another circumferential section in the direction F in FIG. 3b, the actuator ring 9 is secured by means of a clip connection 31 in an axial direction of the first axis B. At the same time, rotation of the actuator ring 9 relative to the locking ring 7 is possible. Ribs 33 that are configured on the locking ring 7 ensure that shear forces acting on the catch tabs 11 or the catch arms 21, respectively, are prevented. The catch tab 11 or catch arm 21, respectively, comes into contact with a second stop element 34 of the actuator ring 9 in the vicinity of the ribs 33.

FIG. 5 shows a perspective top view of the connecting device 5 in the locking position, however leaving out the actuator ring 9. As can be seen from FIG. 5, a receptacle 35 of a connecting means that allows joining the connecting device 5 with a first pipe part not shown, is provided in the locking ring 7.

FIG. 6 shows a top view of the locking ring 7 and the actuator ring 9 of the connecting device 5. On the actuator ring 9, particularly on its circumference, a first marking is configured in the form of an elevation 37, while a second marking in the form of an elevation 39 is configured on the circumference of the locking ring 7. The markings 37, 39 enable a user to identify the locking position of the connecting device 5, since the markings 37, 39 are then aligned flush with each other. This is particularly the case when the locking ring 7 and the actuator ring 9 are in the relative position shown in FIG. 2a, i. e. the catch tabs 11 are in their radially inner position.

In the connecting device 5 according to a first embodiment described above, the actuator ring 9 is disposed sectionwise around the locking ring 7 or slid upon the same.

A second embodiment of a connecting device 5′ according to the invention will be explained below with reference to FIGS. 7a to 12b. Those components of the connecting device 5′ that correspond to the ones of the connecting device 5 are identified by the same reference numerals plus a single dash.

Unlike the connecting device 5, the locking ring 7′ is disposed around the actuator ring 9′ in the connecting device 5′.

This results in an internal structure of the actuator ring 9′ that is shown in FIGS. 7a and 7b. The respective slots 15′ are disposed on an outer circumferential surface of the actuator ring 9′.

The slots 15′ further comprise guideways 17′ in which the respective sections 23′ and 25′ are configured, wherein a parking position is defined particularly by the section 25′. However, to allow engagement of the catch tabs 11′ of the locking ring 7′ as shown in particular in FIGS. 8a and 8b, the actuator ring 9′ comprises openings 41′ through which the catch tabs 11′ can extend.

As can be seen from FIG. 8a, the locking ring 7′ is designed such that it can be opened in a section 43′ of its circumference. The locking ring 7′ is placed on the actuator ring 9′ in its open state shown in FIG. 8a and then transferred into the state shown in FIG. 8b, that is, with its the section 43′ closed using a connecting means. Thereafter, the connecting device 5′ is particularly in the configuration shown in FIG. 9a. This means that a closed ring is only obtained after mounting the device and closing the section 43′.

The bolts 13′ are guided in the slot 15′ such that they rest on the guideway 17′, under a spring preload built up by the catch arms 21′. If the locking ring 7′ is rotated relative to the actuator ring 9′, the bolt 13′ is guided in the obliquely running section 23′ of the guideway 21′ and thus moved radially outwards. This at the same time causes the catch tabs 11′ to move into the openings 41′, as particularly shown in FIG. 9b. The inner walls of the openings 41′ define respective second stop elements 34′ for the catch tabs 11′ or catch arms 21′, respectively. In the position shown in FIG. 9b, the bolts 13′ are in section 25′ of the guideway 17′ and thus in the so-called parking position. In this parking position, the connecting device 5′ or the catch tab 11′, respectively, is in the unlocking position. In this position, the second pipe part can be inserted into the connecting device 5′. The bolts 13′ and the catch tabs 11′ can then again be transferred into the position shown in FIG. 9a by rotating the locking ring 7′ relative to the actuator ring 9′ accordingly to achieve that the connecting device 5, 5′ is locked.

It should be noted, however, that a connection with the connecting device 5, 5′ can also be made by inserting the second pipe part into the connecting device 5, 5′ when the latter is in the locking position. The catch tabs 11, 11′ are deflected out of the locking position by an axial movement of the second pipe part and snap back into the undercut 3 after reaching an end position to connect the second pipe part 1.

It is further proposed for the connecting device 5′ that a control ring 47′, particularly as shown in FIGS. 10a and 10b, be provided to enable a user to detect the locking or locking position of the connecting device 5′ from outside.

The control ring 47′ comprises a recess 49′ into which the bolt 13′ extends. The recess 49′ extends sloped relative to a radial direction of the axis B′. This has the effect that the control ring 47′ is rotated relative to the locking ring 7′ when the bolt 13′ is transferred from the locking position shown in FIG. 10a into the unlocking/parking position shown in FIG. 10b. A marking in the form of an elevation 51′ is configured on the control ring 47′. As can be seen from FIGS. 10a and 10b, the locking ring 7′ also comprises a marking in the form of an elevation 39′. If the markings 39′ and 51′ are in flush alignment as shown in FIG. 10a, a user can see from outside that the connecting device 5′ is in the locking position.

Finally, it is proposed to use a cover ring 53′, as particularly shown in FIGS. 11a to 12b, for the connecting device 5′, The cover ring 53′ may be disposed coaxially to the actuator ring 9′ or the locking ring 7′, respectively, either alternatively or in addition to the control ring 47′. FIG. 11a shows a top view of the cover ring 53′, the control ring 47′, and the locking ring 7′ in a locking position of the connecting device 5′, while FIG. 11b shows a cross-sectional view of the connecting device 5′. FIG. 12a substantially matches FIG. 11a, but the connecting device 5′ is in the unlocking/parking position. FIG. 12b substantially matches FIG. 11b, but the connecting device 5′ also is in the unlocking/parking position.

FIG. 11a particularly reveals that he cover ring 53′ comprises a spring hammer element 55′. In addition, a marking in the form of an elevation 57′ is configured on the cover ring 53′. If the connecting device 5′ is in the locking position, the marking 39′ configured on the locking ring 7′, the marking 51′ configured on the control ring 47′, and the marking 57′ configured on the cover ring 53′ are aligned flush with each other.

In addition, the spring hammer element 55′ is engaged in the locking position, i. e. the surface of the spring hammer element 55 is flush with the residual surface of the cover ring 53′. If the connecting device 5′ is in the unlocking position or in a parking position as shown in FIGS. 12a and 12b, the spring hammer element 55′ is disengaged from the resting position shown in FIGS. 11a and 11b and into a triggering and/or indicator position shown in FIGS. 12a and 12b. This means that the spring hammer element 55′ projects from the surface of the cover ring 53′. This is another indication to the user that the connecting device 5′ is not in the locking position. This indication is in addition to the markings 39′, 51′, and 57′ not being in flush alignment, as shown in FIG. 12a.

As can furthermore be seen from FIG. 12b, the spring hammer element 55′ exerts an additional force on the bolt 13′. This force increases particularly when the cover ring 53′ is guided against the stop 4 of the second pipe part 1. If the spring hammer element 55′ comes into contact with the stop 4, the bolt 13′ is forced out of its parking position and moves from the section 25′ into the section 23′ of the slot 15′ or the guideway 17′, respectively. But this has the effect that the catch tab 11′ is forced into the locking position by the spring force built up via the catch arm 21′, while at the same time the locking ring 7′ and the actuator ring 9′ rotate relative to each another. The connecting device 5′ is therefore automatically transferred into the locking position, and the first and second pipe parts are automatically connected. This means that a “snapback” occurs that is triggered by the spring hammer element 55′ when the guide element has been in the essentially stable parking position.

FIGS. 13a to 13d show a third embodiment of a connecting device 5″ according to the invention. Those components of the connecting device 5′ that correspond to the ones of the connecting device 5 are identified by the same reference numerals plus two dashes.

As can in particular be seen in FIG. 13a, the locking ring 7″ has a modified configuration. For example, the locking ring 7″ includes a latching device 59″.

FIGS. 13a and 13b show the connecting device 5″ in a position in which the catch tabs 11″ are in a locking position. As can in particular be seen in FIG. 13b, the latching device 59″ includes a latching element that is connected in a rotation-proof manner to the locking ring 7″ and has the form of a latching bolt 61″ that is preloaded using a restoring device in the form of a spring 63″.

A trigger element in the form of a trigger lug 65″ is configured integral with the latching bolt 61′. As can in particular be seen in FIG. 13b, the trigger lug 65″ extends through the opening in the form of a slit 67″ configured in the actuator ring 9″. Compared to the actuator rings of the connecting devices described above, the actuator ring 9″ further comprises a recess 69″.

As mentioned above, FIGS. 13a and 13b show the connecting device 5″ in a locking position. If the actuator ring 9″ is moved along the arrow 71″ in FIG. 13b relative to the locking ring 7″ and the latching bolt 61″ partially supported in it, the connecting device 5″ can be transferred into a latching position shown in FIGS. 13c and 13d. Rotation along the arrow 71″ has the effect that the latching bolt 61″ that is connected in a rotation-proof manner to the locking ring 7″ is guided along the surface of the actuator ring 9″ until it enters the area of the recess 69″.

Due to the preloading of the latching bolt 61″ by the spring 63″, the latching bolt 61″ “snaps” into the recess 69″. This ensures rotation-proof latching of the locking ring 7″ relative to the actuator ring 9″ in a latching position. This latching position particularly corresponds with an unlocking position of the connecting device 5″.

The catch tabs 11″ of the locking ring 7″ have been transferred into the unlocking position shown in FIG. 13c against a spring force built up by the catch arms 21″ by means of a slot not shown in FIGS. 13a to 13d that interacts with the bolt 13″ of the catch tabs 11″. The connecting device 5″ is thus in a stable position that is suitable for transporting the connecting device 5″, since even external vibrations cannot easily release the interlock of the locking ring 7″ and the actuator ring 9″.

But if a connection of the connecting device 5″ with a second pipe part not shown in FIGS. 13a to 13d is made, the latching in the latching position is substantially released automatically. For this purpose, the latching device 59″ comprises the trigger element described above in the form of the trigger lug 69″. If the connecting device 5″ connects to a second pipe part, the trigger lug 65″ contacts the second pipe part, particularly a stop element, such as the step 4 of the second pipe part. In this process, a force is applied on the trigger lug 65″, particularly along the arrow 73″ in FIG. 13d. This force causes a movement not only of the trigger lug 65″ but also of the latching bolt 61″ that is integral with it, against the force of the spring 63″. Since the latching bolt 61″ leaves the recess 69″, the spring force built up by the catch arms 21″ causes the connecting device 5″ to automatically “snap back” into the position shown in FIGS. 13a and 13b, that is, the connecting device 5″ is transferred into the locking position.

The latching device can be used as an alternative or in addition to implementing the parking position and/or using a cover ring. When the cover ring is omitted, a connecting device comprising just two individual components is obtained, particularly when using the latching device: the actuator ring 9″ and the locking ring 7″.

In the embodiment shown in FIGS. 13a to 13d, the locking ring 7″ is a first component and the actuator ring 9″ is a second component. In other embodiments not shown here, this assignment can be reversed—i. e. kinematically vice versa—that is, the actuator ring 9″ represents a first component on which the latching device or a latching element comprised by said latching device is configured in a rotation-proof manner, while the locking ring 7″ represents a second component that can be latched in a friction and positive locking engagement with the actuator ring 9″.

The features described in the above description, the figures, and the claims can be relevant both individually and in any combination for the various embodiments of the invention.

### REFERENCE SYMBOLS

1 Pipe part
3 Undercut
4 Step
5, 5′, 5″ Connecting device
7, 7′, 7″ Locking ring
9, 9′, 9″ Actuator ring
11, 11′, 11″ Catch tab
13, 13′, 13″ Bolt
15, 15′ Slot
17, 17′ Guideway
19 Cover
21, 21′, 21″ Catch arm
23, 23′ Section
25, 25′ Section
27, 27′ Indentation
29 O-ring
31 Clip connection
33 Rib
34, 34′ Stop element
35 Receptacle
37 Elevation
39, 39′ Elevation
41′ Opening
43′ Section
45, 45′, 45″ Bevels
47′ Control ring
49′ Recess
51′ Elevation
53′ Cover ring
55′ Spring hammer element
57′ Elevation
59″ Latching device
61″ Latching bolt
63″ Spring
65″ Trigger lug
67″ Slit
69″ Recess
71″ Arrow
73″ Arrow
A Section
B, B Symmetry axis
E Direction
F Direction

1. A connecting device (5, 5′) for connecting at least two pipe parts, wherein the connecting device (5, 5′) is connected at least sectionwise to a first pipe part, and a detachable connection to at least one connecting element (3, 4) operatively connected to a second pipe part (1) can be produced by means of said connecting device (5, 5′), the connecting device (5, 5′) comprises at least one locking ring (7, 7′) with at least two elastically movable catch tabs (11, 11′) protruding in a radially inward direction of the locking ring (7, 7′), and at least one actuator ring (9, 9′) for moving the catch tabs (11, 11′) out of at least one locking position, in which at least one of the catch tabs (11, 11′) is engaged in the connecting element (3), into at least one unlocking position in which the engagement is detached, and vice versa, wherein the respective catch tab (11, 11′) is resiliently mounted at a first end on the locking ring (7, 7′) via at least one catch arm (21, 21′), and a second end of the catch tab (11, 11′) opposite from the first end is freely movable, characterized in that at least one guide element (13, 13′) is provided in the vicinity of the second end of the respective catch tab (11, 11′) and that the respective guide element (13, 13′) is guided in at least one slot (15, 15′) comprised by the actuator ring (9, 9′), in such a manner that the catch tab (11, 11′) can be forced into the locking position by the spring force built up by the catch arm (21, 21′) and can be forced out of the locking position against said spring force and into the unlocking position by means of a movement of the actuator ring (9, 9′) relative to the locking ring (7, 7′) and/or of the locking ring (7, 7′) relative to the actuator ring (9, 9′).

2. The connecting device according to claim 1, characterized in that the first pipe part can be connected to the actuator ring or the locking ring using at least a first connecting device.

3. The connecting device according to claim 1, characterized in that the connecting element (3) is connected to the second pipe part (1), in particular by means of at least one second connecting device, in that it is formed at least sectionwise, preferably completely, in said second pipe part (1) and/or comprises at least one receptacle for the catch tab (11, 11′), in particular including at least one indentation, at least one groove and/or at least one undercut (3), wherein said receptacle (3) preferably encompasses the second pipe part (1) completely.

4. The connecting device according to claim 1, characterized in that the connecting element comprises at least one first stop element (4) for the connecting device (5, 5′), in particular the locking ring (7, 7′) and/or the actuator ring (9, 9′), preferably for limiting a movement of the connecting device (5, 5′) in an axial direction along a first axis (B, B′), wherein said first axis preferably corresponds to a longitudinal axis of the first pipe part and/or the second pipe part and/or a symmetry axis of the actuator ring (9, 9′) and/or the locking ring (7, 7′).

5. The connecting device according to claim 1, characterized in that the locking ring (7′) can be radially pushed or slid at least onto outside sections of the actuator ring (9′) and/or can be disposed on said actuator ring (9′) such that it radially surrounds at least sections thereof, or that the actuator ring (9) can be radially pushed or slid at least onto outside sections of the locking ring (7) and/or can be disposed on said locking ring (7) such that it radially surrounds at least sections thereof, wherein the actuator ring (9) and the locking ring (7) can preferably be connected by means of at least one third connecting device (31), preferably in such a manner that a movement in an axial direction of the first axis (B, B′) is prevented and a rotational movement of the actuator ring (9, 9′) relative to the locking ring (7, 7′) about the first axis (B, B′) is possible.

6. The connecting device according to claim 1, characterized in that the locking ring (7′) or the actuator ring can be opened and/or closed at least at one circumference point (43′) by means of at least one fourth connecting device, wherein preferably a plurality of individual segments of the locking ring or the actuator ring are provided which can be connected to each other via a plurality of fourth connecting devices.

7. The connecting device according claim 1, characterized in that the catch tab (11, 11′) and/or the catch arm (21, 21′) is supported at least in the locking position in a direction along the first axis (B, B′) by at least one second stop element (34) encompassed by the actuator ring (9, 9′) and/or comes into contact with the second stop element (34) when a force acting onto the connecting device (5, 5′) in the direction of the first axis (B, B′) builds up, wherein particularly the catch tab (11′), at least in the locking position, at least sectionwise, projects into at least one opening (41′) formed in the actuator ring (9′) or extends through said opening (41′).

8. The connecting device according to claim 1, characterized in that the catch arm (11, 11′) and/or the catch tab (21, 21′) extends substantially in a direction perpendicular to the first axis (B, B′) and/or tangential to a circumferential direction of the locking ring (7, 7′) and/or actuator ring (9, 9′).

9. The connecting device according to claim 1, characterized in that the catch tab (11, 11′) comprises at least one bevel (45, 45′) in a direction along the first axis, particularly in order to achieve a deflection of the catch tab (11, 11′) and/or the catch arm (21, 21′) out of the locking position by sliding the second pipe part (1) into the actuator ring (9, 9′) and/or the locking ring (7, 7′) along the first axis (B, B′).

10. The connecting device according to claim 1, characterized in that the guide element includes at least one bolt (13, 13′) extending parallel to the first axis (B. B′) and/or that preferably at least two guide elements (13, 13′) are provided, preferably disposed on opposite sides of the catch tab (11, 11′).

11. The connecting device according to claim 1, characterized in that the slot (15, 15′) may include at least one guideway (17, 17′) on which the guide element (13, 13′) rests, is forced into contact with the guideway (17, 17′), in particular by means of the spring force built up by the catch arm (21, 21′), wherein said guideway (17, 17′) is preferably inclined with respect to a circumferential direction about the first axis (B, B′), particularly the surface of the guideway (17, 17′) on which the guide element (13, 13′) rests extends at different radial distances from the first axis (B, B′).

12. The connecting device according to claim 11 characterized in that the inclination with respect to the circumferential direction about the first axis (B, B′) is at least sectionwise 5° to 40°, preferably 10° to 35°, preferred 15° to 20°, more preferred 20° to 25°, most preferred 22°, the guideway (17, 17′) being curved along the circumferential direction about the first axis (B, B′) and/or the inclination decreases as the radial spacing from the first axis (B, B′) decreases.

13. The connecting device according to claim 11, characterized in that at least one surface contour section (25, 25′) is configured in the surface of the guideway (17, 17′) that provides a parking position of the connecting device (5, 5′), particularly the locking ring (7, 7′), the catch tab (11, 11′), the catch arm (21, 21′), and/or the guide element (13, 13′), the surface of the guideway (17, 17′) comprises a constant radial distance from the first axis (B, B′) for providing the parking position, and/or the distance of the surface of the guideway (17, 17′) from the first axis (B, B′) increases at least sectionwise in both circumferential directions, starting from the surface contour section (25, 25′) that provides the parking position.

14. The connecting device according to claim 1, characterized in that the actuator ring (9, 9′), particularly the slot (15, 15′), is designed such that, for transferring the catch tab (11, 11′) from the locking position into the unlocking position, the actuator ring (9, 9′) is moved across an angular range from 2° to 12°, preferred from 4° to 10°, more preferred from 5° to 9°, even more preferred from 6° to 8°, and most preferred by 7°.

15. The connecting device according to claim 1, characterized in that the catch arm (11, 11′) is supported by the slot (15, 15′) at least sectionwise along the first axis (B, B′), particularly rests flatly, at least sectionwise, in a plane perpendicular to the first axis (B, B′) on the surface of the slot (15, 15′).

16. The connecting device according to claim 1, characterized by at least one latching device (59″) for latching, particularly rotation-proof latching, of the actuator ring (9″) relative to the locking ring (7″) with respect to the first axis in at least one first latching position, particularly the parking position, said latching position preferably corresponding to the unlocking position of the catch tabs (11″).

17. The connecting device according to claim 16, characterized in that the latching device (59″) includes at least one latching element (61″) that is connected in a rotation-proof manner to a first element (7″) and/or is movably mounted, preferably in a direction along the first axis (B, B′), in said first element (7″), wherein a second element (9″) is latched by means of said latching element (61″) relative to the first element (7″) in the latching position, particularly said latching element (61″) engaging in a recess (69″) of the second element (9″) and/or said latching element (61″) being forced into engagement with said recess (69″) by at least one restoring device, such as at least one spring element (63″).

18. The connecting device according to claim 16, characterized in that the latching device (59″) includes at least one trigger element (65″) for releasing the latching of the actuator ring (9″) relative to the locking ring (7″), particularly for moving the latching element (61″) out of its engagement, preferably against a restoring force built up by the restoring device (63″).

19. The connecting device according to claim 16, characterized in that the trigger element (65″) and the latching element (61″) are at least sectionwise integral.

20. The connecting device according to claim 17, characterized in that the first element is the locking ring (7″) and the second element is the actuator ring (9″), or that the first element is the actuator ring and the second element is the locking ring.

21. The connecting device according to claim 18, characterized in that the trigger element (61″) is at least sectionwise disposed on a side of the actuator ring (9″) that is facing away from the locking ring (7″), in particular that the trigger element (65″) extends at least sectionwise through the actuator ring (7″), and the trigger element (65″) can preferably be brought into contact with the second pipe part (1), in particular when the latching device (59″) is in the latching position.

22. The connecting device according to claim 16, characterized in that the actuator ring (9″) is preloaded with respect to the locking ring (7″) in the latching position by the spring force built up by the catch arms (21″).

23. The connecting device according to claim 1, characterized in that the actuator ring (9, 9′) comprises at least one first marking (37) and the locking ring (7, 7′) comprises at least one second marking (39, 39′), wherein the first marking (37) and the second marking (39, 39′) are aligned flush with each other when the connecting device (5), particularly the catch tab (11), is in the locking position, and/or the first marking (37) and the second marking (39) are not flush when the connecting device (5), particularly the catch tab (11), is in the unlocking position, the latching position, and/or the parking position.

24. The connecting device according to claim 1, characterized by at least one control ring (47′) that can be arranged coaxially to the actuator ring (9′) and/or the locking ring (7′), wherein said control ring (47′) comprises at least one third marking (51′), wherein particularly this third marking (51′) on the one hand and the first and/or second marking (39′) on the other are aligned flush with each other in the locking position of the connecting device (5′) and are not aligned flush with each other in the unlocking position, the latching position, and/or the parking position of the connecting device (5′).

25. The connecting device according to claim 24, characterized in that the control ring (47′) includes at least one recess (49′) for receiving the guide element (13′) and/or the second end of the catch tab (11′) at least sectionwise, wherein said recess (49′) is preferably inclined relative to a radial direction of the first axis (B, B′).

26. The connecting device according to claim 1, characterized by at least one cover ring (53′) that can be disposed coaxially with the actuator ring (9′), the locking ring (7′), and/or the control ring (47′), wherein said cover ring (53′) includes at least one spring hammer element (55′) that can be transferred from a resting position into a triggering and/or indicator position by means of the guide element (13′), wherein the resting position is taken when the connecting device (5′) is in the locking position and/or the triggering position is taken when the connecting device (5′) is in the unlocking position, the latching position, and/or the parking position.

27. The connecting device according to claim 26, characterized in that the spring hammer element (55′) may further be resiliently seated in the cover ring (53′), wherein this type of seating can build up a restoring force that forces the spring hammer element (55′) into the resting position and/or the spring hammer element (55′) projects in the triggering and indicator positions from the surface of the residual area of the cover ring (53′), wherein said spring hammer element (55′), particularly in the triggering and/or indicator position, is operatively connected with the guide element and/or trigger element (65″), particularly abutting with it or them, in such a manner that a movement of the spring hammer element (55′) from the triggering and/or indicator position into the resting position preferably caused by a force acting on the spring hammer element (55′), particularly a force in addition to the resilient seating, can move the guide element from the parking position, particularly the locking position, and/or the latching element (61″) from the latching position, wherein this movement can preferably be produced during a movement of the cover ring (53′) and/or the spring hammer element (55′) against the connecting element, particularly the first stop element (4).

28. The connecting device according to claim 26, characterized in that the cover ring (53′) comprises at least one fourth marking (57′), wherein this fourth marking (57′) on the one hand and the first marking, the second marking (39′), and/or the third marking (51′) on the other hand are aligned flush with each other in the locking position of the connecting device (5′) and are not aligned flush with each other in the unlocking position, the latching position, and/or the parking position of the connecting device (5′).

29. The connecting device according to claim 24, characterized in that the first marking, the second marking, the third marking, and/or the fourth marking includes at least one indentation, at least one elevation (37, 39, 39′, 51′, 57′), at least one imprint, and/or at least one relief.

30. The connecting device according to claim 1, characterized in that the actuator ring and/or the locking ring (7, 7′) includes at least one sealing device (29, 29′), preferably comprising at least one O-ring (29, 29′), and/or can be connected to the sealing device (29, 29′), and particularly includes at least one recess, such as at least one groove, at least one indentation (27, 27′), and/or at least one undercut for receiving the sealing device (29, 29′).

31. The connecting device according to claim 1, characterized in that the first connecting means, the second connecting means, the third connecting means, and/or the fourth connecting means include(s) at least one snap-lock connection, at least one clamping connection, at least one adhesive connection, at least one clip connection, at least one bayonet connection, and/or at least one screwed connection.

32. A connecting system for connecting at least two pipe parts, comprising at least one connecting device (5, 5′) according to any one of the preceding claims, and at least one connecting element (3, 4) that can be connected to at least one second pipe part (1) and/or is at least sectionwise, preferably completely, encompassed by said second pipe part (1).
